(19) United States
(12) Patent Application Publication
(10) Pub. No.: US 2006/0131083 A1
(43) Pub. Date: Jun. 22, 2006

(54) Capped equalizer bar end joint

(76) Inventors: Hector M. Matthys, Peoria, IL (US); Mark J. Roeder, East Peoria, IL (US); Mark A. Stein, Peoria, IL (US); Billy R. Bedford, Peoria, IL (US)

Correspondence Address: CATERPILLAR INC.;100 N.E. ADAMS STREET, PATENT DEPT., PEORIA, IL, 616296490, US

(21) Appl. No.: 11/017,371

(22) Filed: Dec. 20, 2004

(51) Int. Cl. B62D 55/00

(52) U.S. Cl. 180/9.5

(57) ABSTRACT

An apparatus and method for connecting a track frame of a work machine to an equalizer bar are provided. The method may include aligning a connection pin into a partial open first bore formed on a connection structure of a frame member and aligning the connection pin into a partial open second bore formed on a cap member. The method may further include coupling the cap member to the connection structure so that the connection pin is held between the first and second bores and so that a cap shoulder, which may be arranged on the cap member, is disposed between the connection pin and the connection structure. Moreover, the method may include coupling the cap member to the connection structure so that the connection pin is held between the first and second bores and so that the cap member deforms about a deformation region, which may be disposed on the cap member.

### TECHNICAL FIELD

The present invention relates generally to a suspension assembly for a work machine, and more particularly relates to a connecting assembly for connecting a frame of a work machine to an equalizer bar.

### BACKGROUND

Many work machines, such as track-type tractors, utilize an equalizer bar to support the front of the work machine and to control spacing and tracking characteristics of the machine's track roller frames during operation. Such work machines employ diverse means for connecting the ends of an equalizer bar to respective track roller frames.

A typical equalizer bar configuration for a work machine is shown in FIG. 1. In such a configuration, an equalizer bar 3 connects the roller frames 4 of the side tracks (not shown) to the main frame 5 of a work machine. The equalizer bar 3 is pivotally mounted to the main frame 5 at a pivot connection point 9, so that the left and right end portions 6, 7 of the equalizer bar 3 (and the respective roller frames connected thereto) may pivot up and down depending upon the contour of the terrain over which the work machine is moving. Connection pins 2 are transversely arranged (within throughbores and bearing assemblies) in each end portion 6, 7 of the stabilizer bar 3. Each connection pin 2 is attached to its respective roller frame 4 via two C-shaped mounting brackets 11 affixed on each roller frame 4. For example, at left-end portion 6 of the equalizer bar 3, a first C-shaped mounting bracket 11 is disposed forward of the equalizer bar 3, and a second C-shaped mounting bracket (not shown) is disposed behind the equalizer bar 3 to receive and hold the left-end connection pin 2. Disassembly of the equalizer bar 3 from the left-end roller frame 4 may be accomplished by removing a bolt 12 from each of the two C-shaped mounting brackets 11 (forward and rear), prying partially open the forward and rear mounting brackets 11, and hammering the connection pin 2 out of at least one of the mounting brackets 11 and out of the throughbore and bearing assembly of the equalizer bar 3.

An alternative means for connecting an equalizer bar to a track roller frame includes a connection pin arranged within a transverse throughbore (and a bearing assembly) at one end of an equalizer bar. The connection pin is arranged generally parallel with the track roller frame and is secured to two spaced apart mounting brackets formed on the track roller frame, each mounting bracket having a partial open bore formed therein for receipt of the connection pin. Two caps, each having a partial open bore therein for receiving the connection pin, are mounted atop the mounting brackets to sandwich the connection pin tightly between the two partial bores of the mounting brackets and the two partial bores of the caps. Each cap is attached to the mounting bracket via a set of two threaded bolts, one bolt being positioned and tightened on each side of the partial bore of the cap, the two bolts cooperating to secure the cap tightly to the mounting bracket.

Certain equalizer bar connecting means of the prior art may be improved by providing a coupling structure that better facilitates easy disassembly of an equalizer bar from a track roller. Moreover, certain equalizer bar connecting means may be improved by providing a coupling structure that better manages forces generated within the connecting means during operation of the machine. Further, certain connecting means may be improved by providing a coupling structure that better facilitates uniform assembly of the connecting means.

The present invention is directed at overcoming one or more disadvantages associated with prior means for connecting an equalizer bar to a track roller frame.

### SUMMARY OF THE INVENTION

In one aspect of the present invention, a connecting assembly for connecting a track frame of a work machine to an equalizer bar is provided. The connecting assembly may include a frame member having a connection structure arranged thereon, the connection structure including a partial open first bore formed therein for receipt of a connection pin. The connecting assembly may further include a cap member having a partial open second bore formed therein for receipt of the connection pin. The cap member may also have a cap shoulder arranged thereon for engagement with the connection structure, and the cap shoulder may be configured to be disposed between the connection pin and the connection structure when the cap member is coupled to the connection structure. Further, the cap member may include a deformation region having a reduced cross-sectional area relative an adjacent portion of the cap member, the deformation region facilitating deformation of the cap member about the connection pin during assembly of the cap member to the connection structure. Moreover, the cap member and the connection structure may be configured to hold the connection pin therebetween within the first and second bores thereof when the cap member is coupled to the connection structure.

In another aspect of the present invention, a method for connecting a track frame of a work machine to an equalizer bar is provided. The method may include aligning a connection pin into a partial open first bore formed on a connection structure of a frame member and aligning the connection pin into a partial open second bore formed on a cap member. The method may further include coupling the cap member to the connection structure so that the connection pin is held between the first and second bores and so that a cap shoulder, which may be arranged on the cap member, is disposed between the connection pin and the connection structure. Moreover, the method may include coupling the cap member to the connection structure so that the connection pin is held between the first and second bores and so that the cap member deforms about a deformation region, which may be disposed on the cap member.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments or features of the invention and, together with the description, serve to explain the principles of the invention. In the drawings,

FIG. 1 is a fragmentary front elevational view showing a typical prior art equalizer bar mounted to the main frame of a track-type work machine and coupled to respective track roller frames at each opposite end thereof;

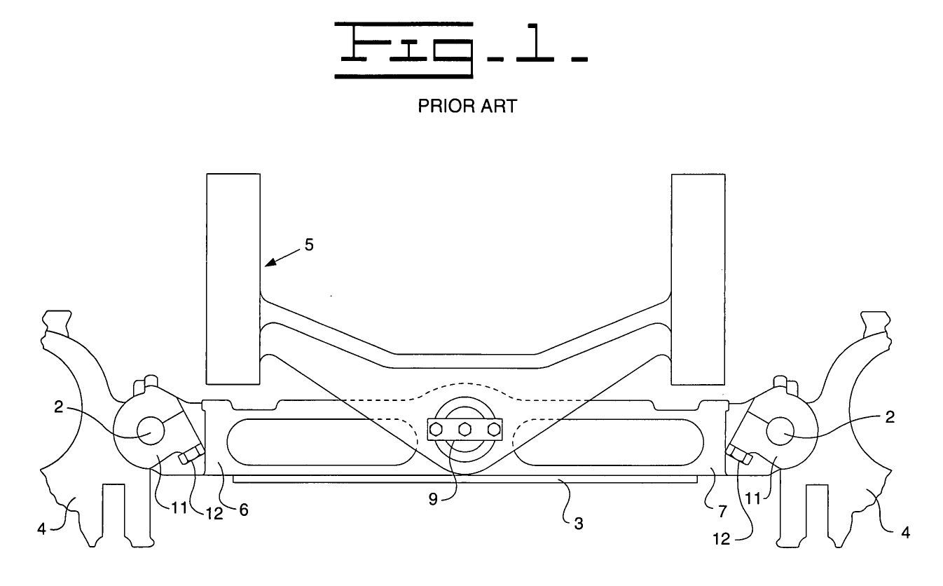

FIG. 2 is an exploded view of a connecting assembly constructed in accordance with the present invention; and

FIG. 3 is a perspective view of the connecting assembly shown in FIG. 2.

Although the drawings depict exemplary embodiments or features of the present invention, the drawings are not necessarily to scale, and certain features may be exaggerated in order to better illustrate and explain the present invention. The exemplifications set out herein illustrate exemplary embodiments or features of the invention and such exemplifications are not to be construed as limiting the scope of the invention in any manner.

### DETAILED DESCRIPTION

Reference will now be made in detail to embodiments or features of the invention, examples of which are illustrated in the accompanying drawings. Wherever possible, the same or corresponding reference numbers will be used throughout the drawings to refer to the same or corresponding parts.

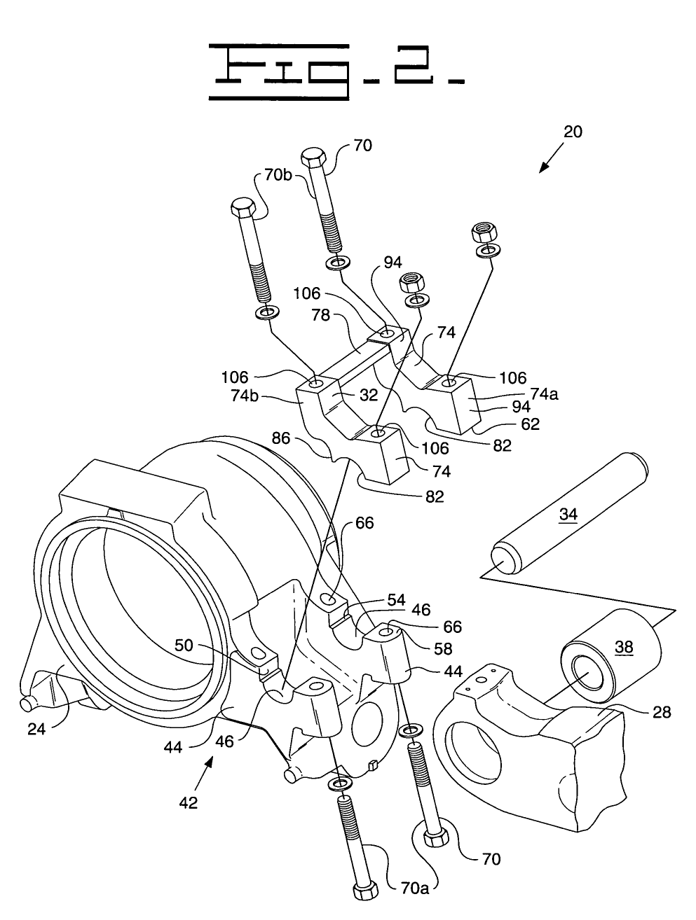

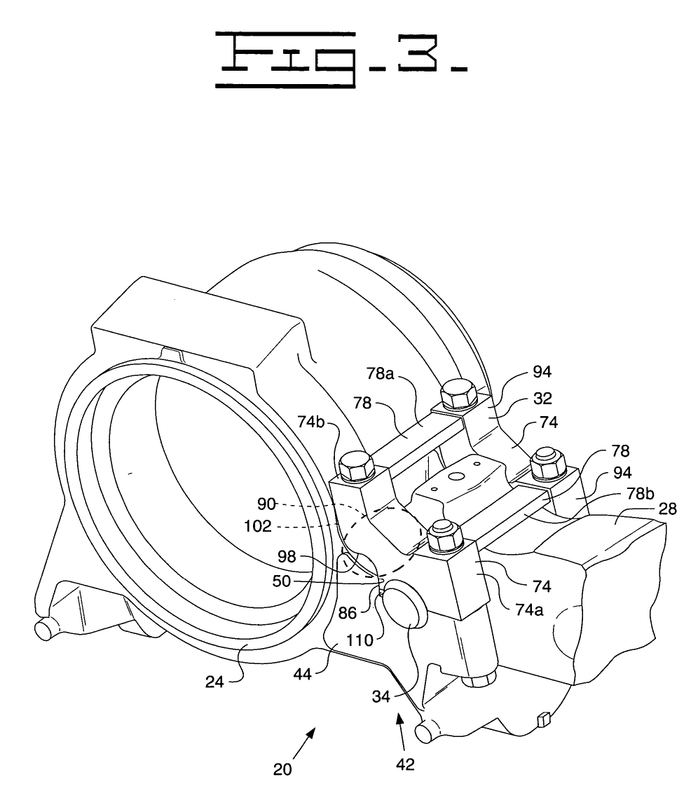

FIGS. 2 and 3 illustrate an exemplary embodiment of a connecting assembly 20, in accordance with the present invention, for coupling a track roller frame member 24 to an equalizer bar 28. The connecting assembly 20 may include the track roller frame member 24, the equalizer bar 28, a cap member 32, and a connection pin 34 coupled to the equalizer bar 28 (for example via a bearing assembly 38) and held between the frame 24 and the cap member 32.

The track roller frame member 24 may be coupled to the track of a mobile machine, such as a track-type tractor or the like. The frame member 24 may include a connection structure 42 arranged thereon. The connection structure 42 may include first and second connection brackets 44, which may be substantially identical to each other. Each connection bracket 44 may include a partial open first bore 46 formed therein for receipt of the connection pin 34. Each connection bracket 44 may further include a support shoulder 50, which may be disposed adjacent the first bore 46. For example, as may be seen in FIG. 2, the support shoulder 50 may be arranged in an offset configuration relative the first bore 46. Thus, a stepped portion 54 of each connection bracket 44 may be arranged between the support shoulder 50 and the first bore 46.

Each connection bracket 44 may further include a first abutment face 58 configured to engage and abut a second abutment face 62 arranged on the cap member 32 when the connection structure 42 and cap member 42 are coupled together. One or more bores 66 may be formed within each connection bracket 44 for receipt of connection members 70 (e.g., bolts) during assembly of the connecting assembly 20. In the embodiment shown in FIGS. 2 and 3, the connection members 70 are arranged in a substantially vertical orientation through the connection structure 42 to desirably manage vertically oriented loads communicated between the frame 24, the connection pin 34, the equalizer bar 28, and the cap member 32.

The cap member 32 may include spaced apart first and second cap member portions 74. As shown in FIGS. 2 and 3, the cap member portions 74 may be substantially identically to each other and may be coupled together via at least one bridge member 78a, 78b. The bridge members 78a, 78b may be arranged substantially parallel to the connection pin 34 and may be configured and arranged to prevent or at least inhibit relative movement of the first and second cap member portions 74, for example toward or away from one another.

Each cap member portion 74 may include a partial open second bore 82 formed therein for receipt of the connection pin 34. Each cap member portion 74 may further include a cap shoulder 86 arranged thereon, for example proximate the second bore 82, for engagement with the corresponding support shoulder 50 of the frame connection structure 42.

Each cap member portion 74 may include bores 106 for receiving connection members 70 (e.g., bolts) therein. For example, bores 106 may be arranged within left and right connection posts 94 arranged at each end of the cap member portion 74.

Each cap member portion 74 may be configured to facilitate appropriate deformation of the cap member 32 about the connection pin 34 during assembly of the cap member 32 to the connection structure 42. For example, each cap member portion 74 may include a deformation region 90 having a reduced cross-sectional area relative an abutting or otherwise adjacent portion (e.g., connection posts 94) of the cap member portion 74. As illustrated in FIGS. 2 and 3, the deformation region 90 may include a recessed portion 98, for example having a concave configuration, that facilitates deformation of the cap member 32 about the connection pin 34 during assembly of the cap member 32 to the connection structure 42. The deformation region 90 may be disposed between the two connection posts 94 of the cap member portion 74. More particularly, the deformation region 90 may be disposed between the cap shoulder 86 and the particular end 74b of the cap member portion 74 that is positioned on an opposite side of the cap shoulder 86 than the partial open second bore 82.

### INDUSTRIAL APPLICABILITY

The present invention may facilitate relatively easy assembly and disassembly processes, while providing a robust coupling mechanism and method for coupling a track frame of a work machine to an equalizer bar.

During assembly, the connection pin 34 may be arranged within the bearing assembly 38 at an end of the equalizer bar 28. The connection pin 34 may then be aligned within the partial open bores 46 of the two connection brackets 44 of the connection structure 42 so that the connection pin 42 is arranged substantially parallel to the track roller frame 24. Next, the cap member 32 may be positioned atop the connection pin 42 so that the connection pin 42 is aligned within the partial open bores 82 of the cap member portions 74. A first set of connection members 70a may be inserted and tightened through bores 66 and bores 106 of the connection structure 42 and cap member 32, respectively, so that the first and second abutment faces 58, 62 of the connection structure 42 and cap member 32, respectively, are held tightly together in abutting engagement. A second set of connection members 70b then may be inserted and tightened through bores 66 and bores 106 of the connection structure 42 and cap member 32, respectively, to cause the deformation region 98 of each cap member portion 74 to deform about the connection pin 34. Due in part to the configuration of the deformation region 98, the first and second abutment faces 58, 62 preferably remain in fixed engagement as the cap member 32 is tightened against the connection structure 42 via connection members 70b. Thus, accurate arrangement of the connection pin 34, the cap member 32, and the connection structure 42 with respect to each other is facilitated, and overall movement of the cap member 32 relative the connection structure 42 during assembly of the connecting assembly 20 is minimized.

When the connecting assembly 20 is fully assembled, the cap member 32 and the connection structure 42 are configured to tightly hold the connection pin therebetween within the first and second partial open bores 46, 82 thereof. Moreover, each cap shoulder 86 may rest between the connection pin 34 and the support shoulder 50 of the respective connection bracket 44. This configuration may be permitted, in one aspect, due to the offset configuration of the support shoulder 50 relative the partial open first bore 46. For example, the stepped portion 54 of each connection bracket 44 facilitates entry of the respective cap shoulder 86 between the connection pin 34 and the support shoulder 50 by creating a recess 110 between the connection pin 34 and the support shoulder 50 in which the cap shoulder 86 may rest. This arrangement permits the cap shoulder 86 to engage the support shoulder 50 when the equalizer bar 28 exerts a force on the connection pin 34 and the cap member 32 toward the frame 24. It should be appreciated that engagement between the cap shoulder 86 and the support shoulder 50 may reduce resulting shear stresses that may otherwise be caused within the connection members 70.

Disassembly of the connecting assembly 20 shown in FIGS. 2 and 3 may be performed by removing the connection members 70, lifting the cap member 32 away from the connection structure 42 of the frame 24 and the connection pin 34, and removing the connection pin 34 from the first partial open bores 46 of the connection structure 42.

From the foregoing it will be appreciated that, although specific embodiments of the invention have been described herein for purposes of illustration, various modifications may be made without deviating from the spirit or scope of the invention. Other embodiments of the invention will be apparent to those skilled in the art from consideration of the specification and figures and practice of the invention disclosed herein. It is intended that the specification and disclosed examples be considered as exemplary only, with a true scope and spirit of the invention being indicated by the following claims and their equivalents. Accordingly, the invention is not limited except as by the appended claims.

What is claimed is:

1. A connecting assembly for connecting a track frame of a work machine to an equalizer bar, comprising:
a frame member having a connection structure arranged thereon, the connection structure including a partial open first bore formed therein for receipt of a connection pin; and
a cap member having a partial open second bore formed therein for receipt of the connection pin, the cap member further having a cap shoulder arranged thereon for engagement with the connection structure;
wherein:
the cap member and the connection structure are configured to hold the connection pin therebetween within the first and second bores thereof when the cap member is coupled to the connection structure; and
the cap shoulder is configured to be disposed between the connection pin and the connection structure when the cap member is coupled to the connection structure.

2. The connecting assembly of claim 1, wherein:
the connection structure of the frame member includes a support shoulder disposed thereon; and
the cap shoulder is configured to be disposed between the connection pin and the support shoulder when the cap member is coupled to the connection structure.

3. The connecting assembly of claim 1, wherein:
the cap shoulder is arranged on the cap member adjacent the second bore; and
the support shoulder is arranged on the connection structure adjacent the first bore.

4. The connecting assembly of claim 3, wherein the support shoulder is arranged in an offset configuration relative the first bore.

5. The connecting assembly of claim 4, wherein a stepped portion of the connection structure is disposed between the support shoulder and the first bore.

6. The connecting assembly of claim 3, wherein:
the connection structure is configured to define a recess between the support shoulder and the connection pin when the connection pin is coupled to the connection structure; and
the cap shoulder is configured to be arranged within the recess when the cap member is coupled to the connection structure.

7. The connecting assembly of claim 1, wherein:
the connection structure includes a first abutment face;
the cap member includes a second abutment face; and
the first and second abutment faces are configured and arranged to be held together in abutting relation when the cap member is coupled to the frame connection structure.

8. The connecting assembly of claim 7, wherein the second abutment face is disposed on an opposite side of the second bore than the cap shoulder.

9. The connecting assembly of claim 7, wherein the cap member is geometrically configured to facilitate deformation of the cap member about the connection pin during assembly of the cap member to the connection structure.

10. The connecting assembly of claim 7, wherein the cap member includes a deformation region having a reduced cross-sectional area relative an adjacent portion of the cap member, the deformation region facilitating deformation of the cap member about the connection pin during assembly of the cap member to the connection structure.

11. The connecting assembly of claim 10, wherein the deformation region includes a recessed portion.

12. The connecting assembly of claim 10, wherein the deformation region includes a concave portion.

13. The connection assembly of claim 10, wherein the deformation region is disposed on an opposite side of the cap shoulder than the partial open second bore.

14. The connecting assembly of claim 1, wherein:
the cap member includes a first cap member portion and a second cap member portion, the first and second cap member portions being spaced apart and each of the first and second cap member portions having a partial open bore formed therein for receipt of the connection pin;
wherein the first and second cap member portions and the connection structure are configured to hold the connection pin between the cap member portions and the connection structure within the bores thereof when the cap member portions are coupled to the connection structure, each of the first and second cap member portions having a cap shoulder arranged thereon configured to be disposed between the connection pin and the connection structure when the cap member is coupled to the connection structure.

15. The connecting assembly of claim 14, wherein the first and second cap member portions are coupled together via at least one bridge member.

16. The connecting assembly of claim 15, wherein the bridge member is arranged substantially parallel to the connection pin.

17. The connecting assembly of claim 15, wherein the bridge member is configured and arranged to prevent or at least inhibit relative movement of the first and second cap member portions toward one another.

18. The connecting assembly of claim 1, wherein the connection pin is coupled to an equalizer bar.

19. The connecting assembly of claim 18, wherein the frame member is coupled to a track of a mobile machine.

20. A connecting assembly for connecting a track frame of a work machine to an equalizer bar, comprising:
a frame member having a connection structure arranged thereon, the connection structure including a partial open first bore formed therein for receipt of a connection pin; and
a cap member having a partial open second bore formed therein for receipt of the connection pin;
wherein:
the cap member includes a deformation region having a reduced cross-sectional area relative an adjacent portion of the cap member, the deformation region facilitating deformation of the cap member about the connection pin during assembly of the cap member to the connection structure; and
the cap member and the connection structure are configured to hold the connection pin therebetween within the first and second bores thereof when the cap member is coupled to the connection structure.

21. The connecting assembly of claim 20, wherein the deformation region includes a recessed portion.

22. The connecting assembly of claim 20, wherein the deformation region includes a concave portion.

23. The connection assembly of claim 20, wherein the deformation region is disposed on an opposite side of the cap shoulder than the partial open second bore.

24. A method for connecting a track frame of a work machine to an equalizer bar, comprising:
aligning a connection pin into a partial open first bore formed on a connection structure of a frame member;
aligning the connection pin into a partial open second bore formed on a cap member; and
coupling the cap member to the connection structure so that the connection pin is held between the first and second bores and so that a cap shoulder arranged on the cap member is disposed between the connection pin and the connection structure.

25. The method of claim 24, including:
coupling a first side of the cap member to the connection structure so that a first abutment face of the connection structure engages a second abutment face of the cap member; and
coupling a second side of the cap member to the connection structure so that the cap member deforms about a deformation region of the cap member.

26. The method of claim 24, wherein throughout the step of coupling a second side, the first and second abutment faces remain in substantial abutting engagement.

27. The method of claim 24, wherein the step of coupling a second side includes causing the cap member to deform about the connection pin.

28. The method of claim 24, wherein:
the cap member includes a deformation region having a reduced cross-sectional area relative an adjacent portion of the cap member; and
the step of coupling the cap member to the connection structure includes causing the deformation region of the cap member to deform about the connection pin.

29. The method of claim 28, wherein the deformation region includes a recessed portion configured to deform about the connection pin during assembly of the cap member to the connection structure.

30. A method for connecting a track frame of a work machine to an equalizer bar, comprising:
aligning a connection pin into a partial open first bore formed on a connection structure of a frame member;
aligning the connection pin into a partial open second bore formed on a cap member; and
coupling the cap member to the connection structure so that the connection pin is held between the first and second bores and so that the cap member deforms about a deformation region disposed on the cap member.

31. The method of claim 30, wherein:
the cap member includes a deformation region having a reduced cross-sectional area relative an adjacent portion of the cap member; and
the step of coupling the cap member to the connection structure includes causing the deformation region of the cap member to deform about the connection pin.
